(19) United States
(12) Patent Application Publication
(10) Pub. No.: US 2019/0095802 A1
(43) Pub. Date: Mar. 28, 2019

(54) HEURISTIC AND NON-SEMANTIC PREDICTION OF THE COST TO FIND AND REVIEW DATA RELEVANT TO A TASK

(71) Applicant: International Business Machines Corporation, Armonk, NY (US)

(72) Inventors: Roger C. Raphael, San Jose, CA (US); Rajesh M. Desai, San Jose, CA (US); Nazrul Islam, San Jose, CA (US); Theodore S. Barassi, Washington, DC (US)

(21) Appl. No.: 15/715,047

(22) Filed: Sep. 25, 2017

(51) Int. Cl. G06N 5/04; G06F 17/30; G06Q 30/02

(52) U.S. Cl. CPC G06N 5/04; G06Q 30/0283; G06F 17/3053; G06F 17/30011

(57) ABSTRACT

Provided are techniques for heuristic and non-semantic prediction of the cost to find and review data that is relevant to a task. A corpus of documents is accessed for a domain. Terms associated with the domain are accessed, where the terms have an order on a list. For each of the documents, term positional dispersion is determined for each of the terms in the ordered list associated with the domain. Then, a document review quanta is determined for the document based on a summation of the term positional dispersion for each term in that document adjusted by a weight. A subset of documents in the corpus of documents are selected that are to be reviewed based on the document review quanta for each of the selected documents exceeding a threshold.

### FIELD

Embodiments of the invention relate to computer system implemented prediction of the cost to find and review data that is relevant to a task.

### BACKGROUND

Sometimes a task requires searching data for information relevant to accomplishing the task. Litigation is one example of such a task, in which case the data includes documents that have been rendered machine readable. In litigation, computer system searching of such documents is one aspect of what is commonly referred to as “discovery.” As part of discovery, documents for which computer system implemented searching finds matches may be subject to review by legal experts.

Since discovery costs may be primary contributors to the expensive and increasing costs of litigations, it is common to predict the cost of a litigation matter in an effort to make early decisions.

### SUMMARY

Provided is a computer system implemented method for heuristic and non-semantic prediction of the cost to find and review data that is relevant to a task. The method comprises a computer system: accessing a corpus of documents for a domain; accessing terms associated with the domain, wherein the terms have an order on a list, with terms having more relative importance to the domain being higher on the list; for each of the documents, determining term positional dispersion for each of the terms in the ordered list associated with the domain using a number of term occurrences in the document for a given term, a positional mean of relative position of the given term in the document, and a positional value of the given term at a particular position and determining a document review quanta for the document based on a summation of the term positional dispersion for each term in that document adjusted by a weight; and selecting a subset of documents in the corpus of documents that are to be reviewed based on the document review quanta for each of the selected documents exceeding a threshold.

Provided is a computer program product for heuristic and non-semantic prediction of the cost to find and review data that is relevant to a task. The computer program product comprises a computer readable storage medium having program code embodied therewith, the program code executable by at least one processor to perform: accessing a corpus of documents for a domain; accessing terms associated with the domain, wherein the terms have an order on a list, with terms having more relative importance to the domain being higher on the list; for each of the documents, determining term positional to dispersion for each of the terms in the ordered list associated with the domain using a number of term occurrences in the document for a given term, a positional mean of relative position of the given term in the document, and a positional value of the given term at a particular position and determining a document review quanta for the document based on a summation of the term positional dispersion for each term in that document adjusted by a weight; and selecting a subset of documents in the corpus of documents that are to be reviewed based on the document review quanta for each of the selected documents exceeding a threshold.

Provided is a computer system for heuristic and non-semantic prediction of the cost to find and review data that is relevant to a task. The computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform operations comprising: accessing a corpus of documents for a domain; accessing terms associated with the domain, wherein the terms have an order on a list, with terms having more relative importance to the domain being higher on the list; for each of the documents, determining term positional dispersion for each of the terms in the ordered list associated with the domain using a number of term occurrences in the document for a given term, a positional mean of relative position of the given term in the document, and a positional value of the given term at a particular position and determining a document review quanta for the document based on a summation of the term positional dispersion for each term in that document adjusted by a weight; and selecting a subset of documents in the corpus of documents that are to be reviewed based on the document review quanta for each of the selected documents exceeding a threshold.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing environment in accordance with certain embodiments.

FIG. 2 illustrates processing in accordance with certain embodiments.

FIG. 3 illustrates, in a flow chart, operations for determining a number of documents for review in accordance with certain embodiments.

FIG. 4 illustrates, in a flow chart, operations for updating weights in accordance with certain embodiments.

FIG. 5 illustrates a computing node in accordance with certain embodiments.

FIG. 6 illustrates a cloud computing environment in accordance with certain embodiments.

FIG. 7 illustrates abstraction model layers in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments of the present invention determine a predicted total review cost for a document corpus using term positional dispersion, as a computational indicator of how much effort may be required to review the document (e.g., manually by a reviewer) so as to determine its relevance to the matter in question.

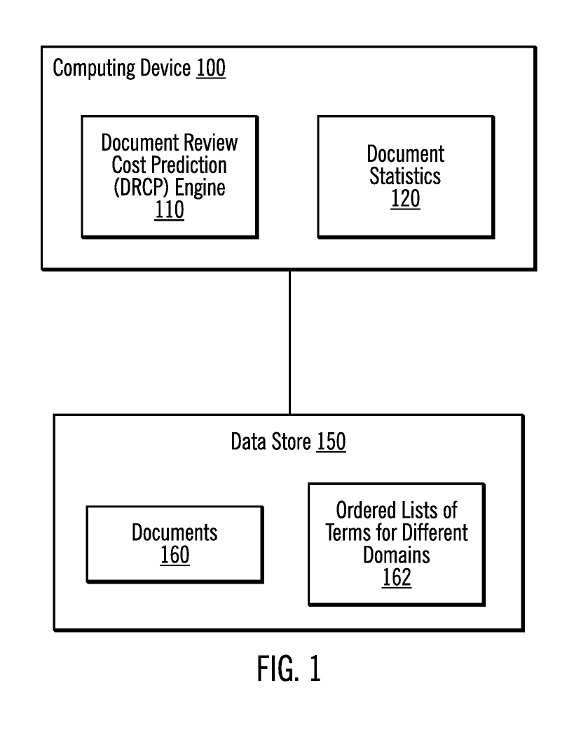

FIG. 1 illustrates, in a block diagram, a computing environment in accordance with certain embodiments. A computing device 100 includes a Document Review Cost Prediction (DRCP) engine 110 and document statistics 120. The computing device 100 is coupled to a data store 150 that stores documents 160 and ordered lists of terms for different domains 162. That is, there may be different domains, and there is a separate ordered list of terms for each of the different domains.

With embodiments, the more scattered a term is, the more the term contributes to document review cost, as review (by a computer or a human) requires more effort to read and co-relate the term in the scattered positions. Also, the DRCP engine 110 considers relative term importance of a term to the matter. This implies that the more a term or type is important, and the more that term is scattered, the document review cost correspondingly multiplies in the heuristic.

The DRCP engine 110 forecasts document review cost (e.g., for legal electronic discovery (“eDiscovery”) for litigation, etc.) by analyzing documents identified for preservation and collection. The DRCP engine 110 covers alternatives, such as applying the same techniques to forecast document review cost for data that has already been preserved and or exported for document reviews or at any stage of the legal eDiscovery process.

The DRCP engine 110 uses document term hits and heuristics to predict the cost of a document review. Document review includes legal review, in which the review is executed by legal experts who can analyze documents that have term hits, for example, in the eDiscovery process. With document review, it is common to execute a search against a document corpus and build a relevant set of documents. The volume of the set of documents and the document review cost per unit volume of the set of documents contribute to the overall document review cost and may be considered to be a contributing factor to other costs (e.g., litigation costs). The document review cost may be dependent on the capability of the reviewer and the complexity of each document in the set of documents. To capture this, the DRCP engine 110 defines a metric called review quanta (Rc).

The complexity of the document review process emanates from factors, such as number of terms identified within the document, relative importance of the terms, term positional dispersions, language of the document, and the size of the document. If the document has terms that are further apart, the reviewer has to spend more time finding and reviewing the context in which the terms appear. The DRCP engine 110 refers to this as term positional dispersion (Pₛ), which is defined for a term in a given set of terms. The DRCP engine 110 refers to relative importance of the terms as term sensitivity (Ts). Term positional dispersion, Pₛ, may be computed in different ways. In certain embodiments, one of the ways to compute term positional dispersion Pₛ is to look for the standard deviation of the term positions for a given term with respect to the positional mean of all terms occurrences in the document for the given term. The term dispersion will be a small number if all of the term occurrences are near to each other and will increase as the term occurrences are more scattered.

The DCRP engine 110 receives a corpus of documents for a domain and receives terms associated with the domain. The terms associated with the domain have an order on a list (i.e., an ordered list of terms), with terms having more relative importance to the domain being higher on the list.

The DRCP engine 110 determines a term positional dispersion (Ps) for each of the terms in the ordered list associated with the domain with Equation (1):

Ps(di)=√(1/NΣ(gᵢ−g̅)²)

where N=number of term occurrences in a document (di) for a given term;
g̅—Positional mean of a relative position of the given term in the document (di)
gᵢ—Positional value of the given term at ᵢth position

Thus, equation (1) is the square root of (1/N Σ(gᵢ−g̅)²). Equation (1) determines term positional dispersion for each of the terms in the ordered list associated with the domain using a number of term occurrences in a document (di) for a given term, a positional mean of a relative position of a given term in the document (di), and a positional value of the given term at a particular position. This may be performed for each document in a corpus of documents.

In certain embodiments, the term position refers to a location of the term offset from the beginning of the document, where the first term occurs in the document is at position 0. In such embodiments, term positional dispersion, Ps(di), is a variance of the term position of all term occurrences in the document. The positional mean of term positions refers to a mean value of the term positions, while positional value of the term at a particular position refers to each term offset in the document.

This process of computing Ps (di) is repeated for all the terms for the given document di. In certain embodiments, terms are an ordered set of terms that are ranked by respective importance, which is represented with weight.

The DRCP engine 110 determines a document review quanta for each document in a corpus of documents related to the term positional dispersion by Equation (2):

Pₛ=Σpₛ(dᵢ)*wᵢ.

where, i=1 to n, di . . . do are the n documents in the corpus; and
pₛ(dᵢ) is the term positional dispersion for a document di
and Wᵢ is a weight of each term.

Thus, equation (2) determines a document review quanta for the document based on a summation of the term positional dispersion for each term in that document adjusted by a weight.

Now, considering all the contributing factors into the document review cost, the DRCP engine 110 determines a total review quanta of a document Rc(di) by Equation (3):

R_{c}(dᵢ)=W1·f(Sₛ)+W2·g(Dₛ)+W3·h(Lₛ)+W4·i(Pₛ)+W5·j(Hₛ)

where R_{c}(dᵢ)=Total Review Quanta for document di;
Ss=review quanta based on the Term Sensitivity of document di;
Ds=review quanta based on the Size of document di;
Ls=review quanta based on the Language of document di;
Ps=review quanta based on the Term Positional Dispersion of document di;
Hs=review quanta based on the History of document di; and
f( ), g( ), h( ), i( ), j( ) are functions and W1, W2, W3, W4, W5 are weights.

Thus, equation (3) determines a total review quanta that takes into account weighted factors of term sensitivity, size, language, term positional dispersion, and history. The DRCP engine 110 automatically updates the weights for each of the factors. In certain embodiments, a user (e.g., a system administrator) may provide input to adjust the weights.

With embodiments, weights are parametrically input to the DRCP engine 110, These weights may come from experts 240 or from a training set. The weights may be arbitrary and may be heuristic numbers. The different weights have different impact on the total review cost. These weights may be provided by users (e.g., system administrators) based on historical cost data 230 and type of documents. The weights may be input as parameters, such that different embodiments may make different choices. In one embodiment, the language (Ls) may have more impact than the size (Ds) of the document than in other embodiments. These values may be adjusted by experts 240 or cost historical data 230 at the runtime of the embodiment.

The functions may also be heuristic. For example, a review firm may be charging $X per gigabyte of data and can be used as Ds=X (dollar amount per gigabyte). Ds can be different for different implementations and can be input to the DRCP engine 110 as input parameters by experts 240 or historical cost data 230.

The DRCP engine 110 determines a predicted total review cost (C) for a corpus of documents by Equation (4):

C={ΣR_{c}(dᵢ)}×Average Review cost per unit R_{c}

Rc(di) is a generic representation of a feature vector that may be used to predict not only the review cost (as in certain embodiments), but may also be used to predict other costs, for example, relevance ranking of the documents, such as to put the documents in order so that the more relevant documents may be reviewed first, or calculate the most relevant document first to be reviewed if the total review expense is restricted (a priori certain dollar amount is available for review and embodiments determine the documents that are most relevant to be reviewed if the complete set cannot be covered).

Thus, equation (4) determines a predicted total review cost for a corpus of documents using a summation of the total review quanta of each document Rc(di) in the corpus and multiplying this by an average review cost per unit Rc.

With embodiment's, the DRCP engine 110 may compare the predicted total review cost C against the actual review cost from the cost historical data 230. Then, the DRCP engine 110 feeds this back into the cost modeling 220 to adjust the accuracy. As the history is built for predicted total review cost C and actual review cost, the DRCP engine 110 adjusts the model for better predictability.

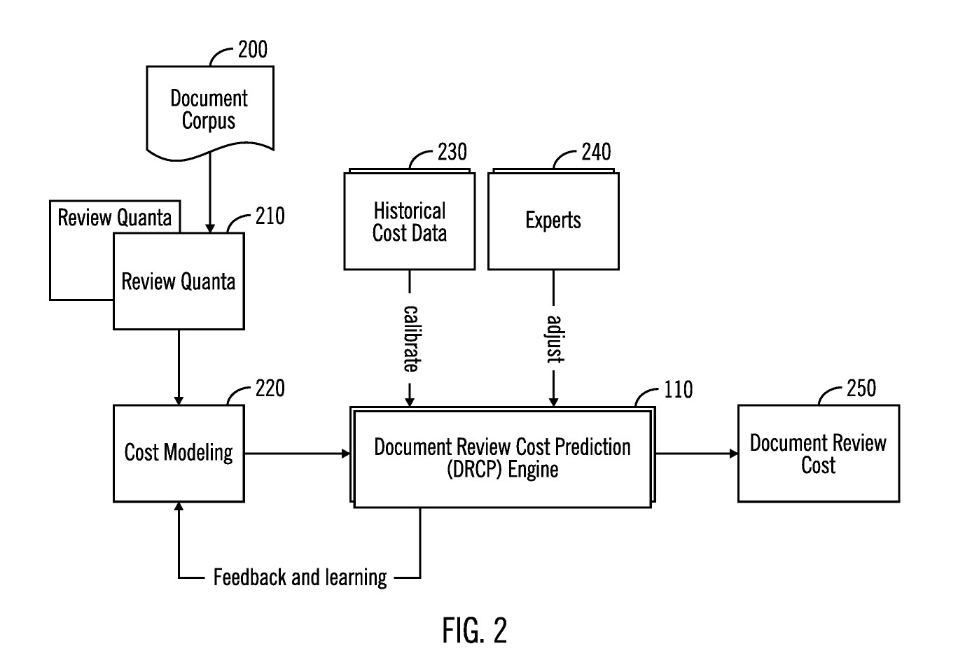

FIG. 2 illustrates processing in accordance with certain embodiments. The DRCP engine 110 identifies review quanta 210 for a document corpus 200. The DRCP engine 110 performs cost modeling 220 using the review quanta 210. The DRCP engine 110 receives the cost modeling 220, a historical cost data 230, and input form experts 240 to generate a document review cost 250. The document review cost 250 may be, for example, a cost to review documents for litigation discovery. The document review costs 250 are embodiments of the R_{c}(dᵢ). It is an embodiment of a feature set that may be applied to any predictions where term positional dispersion is a contributing factor.

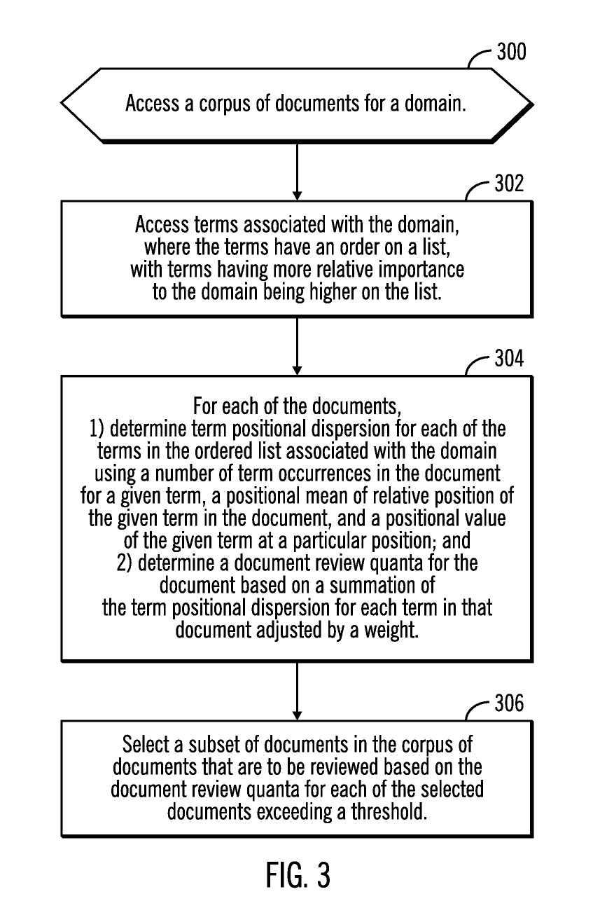

FIG. 3 illustrates, in a flow chart, operations for determining a number of documents for review in accordance with certain embodiments. With embodiments, the processing of FIG. 3 is performed for a particular task (e.g., litigation discovery). Control begins at block 300 with the DRCP engine 110 accessing a corpus of documents for a domain. In various embodiments, accessing the corpus of documents may include receiving the corpus of documents or retrieving the corpus of documents.

In block 302, the DRCP engine 110 accesses terms associated with the domain, where the terms have an order on a list, with terms having more relative importance to the domain being higher on the list. In various embodiments, accessing terms may include receiving the terms or retrieving the terms.

In block 304, the DRCP engine 110, for each of the documents, 1) determines term positional dispersion for each of the terms in the ordered list associated with the domain using a number of term occurrences in the document for a given term, a positional mean of relative position of the given term in the document, and a positional value of the given term at a particular position; and 2) determines a document review quanta for the document based on a summation of the term positional dispersion for each term in that document adjusted by a weight. In block 306, the DRCP engine 110 selects a subset of documents in the corpus of documents that are to be reviewed based on the document review quanta for each of the selected documents exceeding a threshold. The threshold may be modified by, for example, a user (e.g., a system administrator). With embodiments, the threshold is a desired minimum document review quanta value. With embodiments, each of the documents in the corpus may be ranked based on the document review quanta before the selection of block 306.

Thus, embodiments provide an efficient technique to select a smaller number of documents for review (e.g., if there are a thousand documents, it may be that only a hundred are selected). This efficiently narrows down the number of documents to be reviewed.

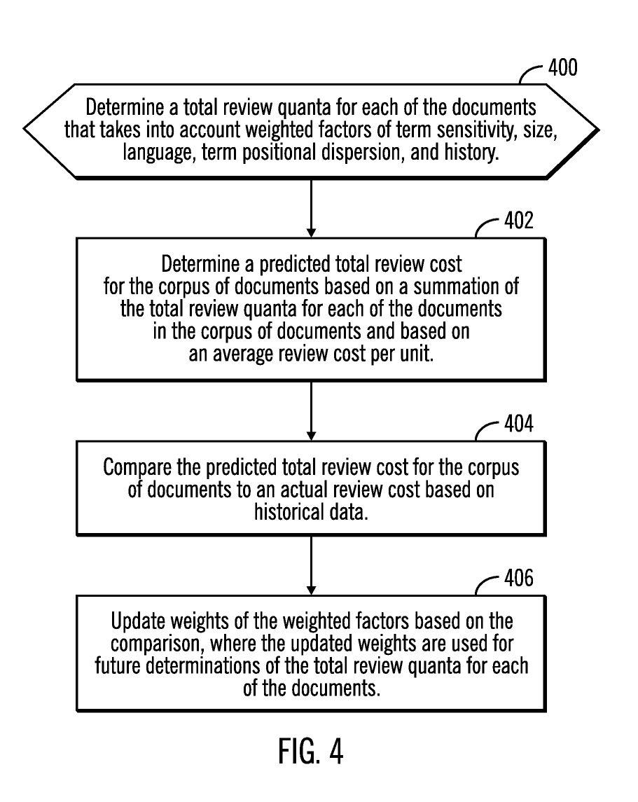

FIG. 4 illustrates, in a flow chart, operations for updating weights in accordance with certain embodiments. Control begins at block 400 with the DRCP engine 110 determining a total review quanta for each of the documents that takes into account weighted factors of term sensitivity, size, language, term positional dispersion, and history. In block 402, the DRCP engine 110 determines a predicted total review cost for the corpus of documents based on a summation of the total review quanta for each of the documents in the corpus of documents and based on an average review cost per unit. In block 404, the DRCP engine 110 compares the predicted total review cost for the corpus of documents to an actual review cost based on historical data. In block 406, the DRCP engine 110 updates weights of the weighted factors based on the comparison, wherein the updated weights are used for future determinations of the total review quanta for each of the documents.

With embodiments, the DRCP engine 110 uses a matter glossary, which is a set of ordered terms or types associated with a matter. The order is a prescribed sensitivity order made by, for example, experts working on the matter.

With embodiments, term positional dispersion may be described as the scattering of a relevant term or a type Terms are pre-defined or input into the DRCP engine 110 such that the DRCP engine 110 calculates the R_{c}(dᵢ) for this set of terms. A set of terms define a type) within a document from a positional point of view relative to the top of the document. If a document is defined as an ordered set of terms, where each term has a position within the document relative to 0 being the start of the document, then the term dispersion for a given term reflects how scattered that given term is within that document.

With embodiments, the term positional dispersion may be described as scattering of a term or type within the term positional space of the document. This may be calculated using the standard deviation or 2nd moment/variance of the term positional values relative to the 0 term of the document when the document is considered as an ordered set of terms and/or types after basic tokenization and type extraction. This may be normalized to the size of the document in token units.

With embodiments, term sensitivity Ts may be described as an ordered list of terms (e.g., used in a hold process). The order of the terms may be derived from a rank assigned to the importance of the term to the matter. This may be derived from deep matter analysis using matter glossaries or manually using a declarative approach in different embodiments.

With embodiments, each reviewer has a review quanta (Rc) that the reviewer is capable of With embodiments, there may also be a parameter to the model that indicates the cost per review quanta (Rc) per hour. With embodiments, the average review cost per unit Rc makes the costs independent of the subjective review capabilities of the reviewer. For example, if there are three paralegals working on a case, with two paralegals being junior and one paralegal being senior, the potential cost per review quanta of each paralegal may be different, and the average review cost per unit Rc is input to the model.

Thus, embodiments provide a heuristic technique using term and/or type dispersion within documents, a weighted approach relative to a matter, and declarative discovery of matter glossaries The terms are defined or input into the DRCP engine 110 such that the DRCP engine 110 searches for these terms. In that sense, the terms are already declared and are used to determine R_{c}(dᵢ). Thus, embodiments provide declarative discovery. This is different from a generic system that calculates the cost for every word in the document, which is not meaningful.

The DRCP engine 110 includes the quality of the documents as a contributing factor to the cost in the early stage when documents are collected and preserved (e.g., for litigation purposes). The DRCP engine 110 takes into account matter specific weightages associated with document review cost.

In certain embodiments, the DRCP engine 110 identifies terms in a document, determines term dispersion for each of the terms by determining a scattering of each of the terms from a positional point, and generates a review quanta based on the term dispersion for each of the terms for predicting the cost of the legal review.

With embodiments, discovery costs for litigation may be significantly reduced by detecting the cost indicators of document processing at early stages of discovery, rather than forecasting costs based on volumes of data.

In certain embodiments, the DRCP engine 110 is directed to heuristic, non-semantic means to predict the cost of document legal review in electronic discovery litigation systems.

Embodiments of the present invention avoid performing manual cost assignment based on document data types, and also avoid developing cost models such as i) models based on historic costs associated with prior reviews of the documents, historical data and associated linear extrapolation, and ii) more complex models based on cost learning. By avoiding certain model-based approaches, embodiments of the present invention tend to reduce computational expense, including the issue of cost model refinement that otherwise is incurred. Also, at least some embodiments of the present invention avoid modifying the quality of the data and or model, such as modifying by adjustments and extrapolations, and avoid compensating for incomplete and/or missing data. Still further, at least some embodiments of the present invention avoid the computational expense and the cost to maintain a machine learning application that predicts cost based on a training set document corpus in association with known costs profiles.

Embodiments of the present invention are advantageous because they provide heuristic and non-semantic prediction of document review cost that is efficient and less costly in terms of use of resources, such as computer processor use and memory/storage use, than conventional techniques. With such an approach, performance may possibly be orders of magnitude better than a semantic driven approach. Hence, a heuristic and non-semantic prediction of document review cost provides faster estimates of the human review cost for a given document corpus. This is at least partly because semantic analysis is more difficult and computationally intensive. For example, when embodiments of the present invention are used as a heuristic tool to find relevance to matter in question of documents within the corpus, the identification of relevant documents may be done more quickly (with less processing time) than other techniques.

Benefits, advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims.

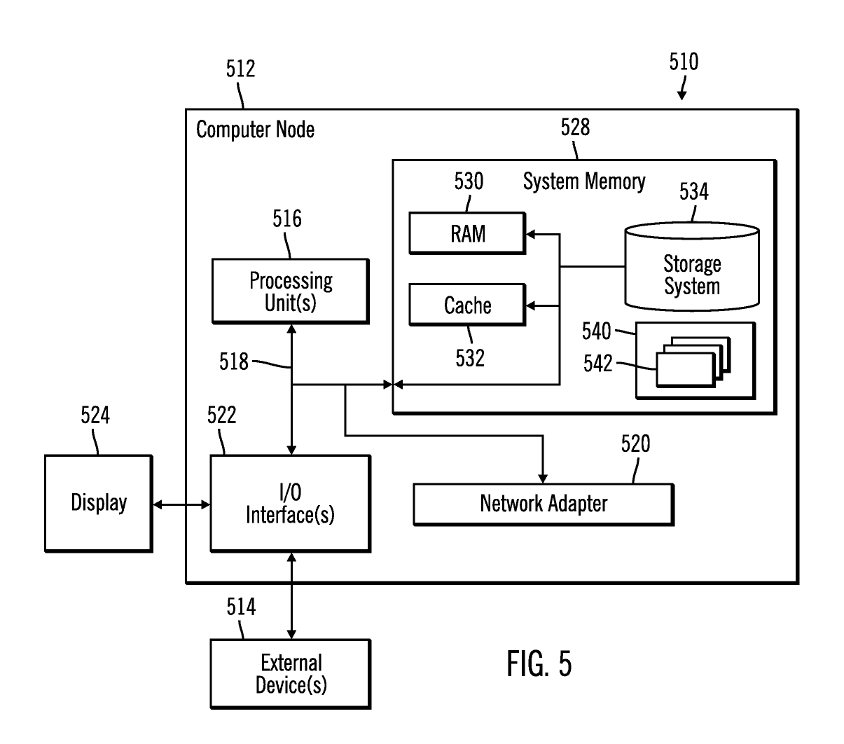

FIG. 5 illustrates a computing environment 510 in accordance with certain embodiments. In certain embodiments, the computing environment is a cloud computing environment. Referring to FIG. 5, computer node 512 is only one example of a suitable computing node and is not intended to suggest any limitation as to the scope of use or functionality of embodiments of the invention described herein. Regardless, computer node 512 is capable of being implemented and/or performing any of the functionality set forth hereinabove.

The computer node 512 may be a computer system, which is operational with numerous other general purpose or special purpose computing system environments or configurations. Examples of well-known computing systems, environments, and/or configurations that may be suitable for use with computer node 512 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer node 512 may be described in the general context of computer system executable instructions, such as program modules, being executed by a computer system. Generally, program modules may include routines, programs, objects, components, logic, data structures, and so on that perform particular tasks or implement particular abstract data types. Computer node 512 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer node 512 is shown in the form of a general-purpose computing device. The components of computer node 512 may include, but are not limited to, one or more processors or processing units 516, a system memory 528, and a bus 518 that couples various system components including system memory 528 to one or more processors or processing units 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer node 512 typically includes a variety of computer system readable media. Such media may be any available media that is accessible by computer node 512, and it includes both volatile and non-volatile media, removable and non-removable media.

System memory 528 can include computer system readable media in the form of volatile memory, such as random access memory (RAM) 530 and/or cache memory 532. Computer node 512 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, system memory 528 may include at least one program product having a set (e.g., at least one) of program modules that are configured to carry out the functions of embodiments of the invention.

Program/utility 540, having a set (at least one) of program modules 542, may be stored in system memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the invention as described herein.

Computer node 512 may also communicate with one or more external devices 514 such as a keyboard, a pointing device, a display 524, etc.; one or more devices that enable a user to interact with computer node 512; and/or any devices (e.g., network card, modem, etc.) that enable computer node 512 to communicate with one or more other computing devices. Such communication can occur via Input/Output (I/O) interfaces 522. Still yet, computer node 512 can communicate with one or more networks such as a local area network (LAN), a general wide area network (WAN), and/or a public network (e.g., the Internet) via network adapter 520. As depicted, network adapter 520 communicates with the other components of computer node 512 via bus 518. It should be understood that although not shown, other hardware and/or software components could be used in conjunction with computer node 512. Examples, include, but are not limited to: microcode, device drivers, redundant processing units, external disk drive arrays, RAID systems, tape drives, and data archival storage systems, etc.

In certain embodiments, the computing device 100 has the architecture of computer node 512. In certain embodiments, the computing device 100 is part of a cloud infrastructure. In certain alternative embodiments, the computing device 100 is not part of a cloud infrastructure.

### Cloud Embodiments

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

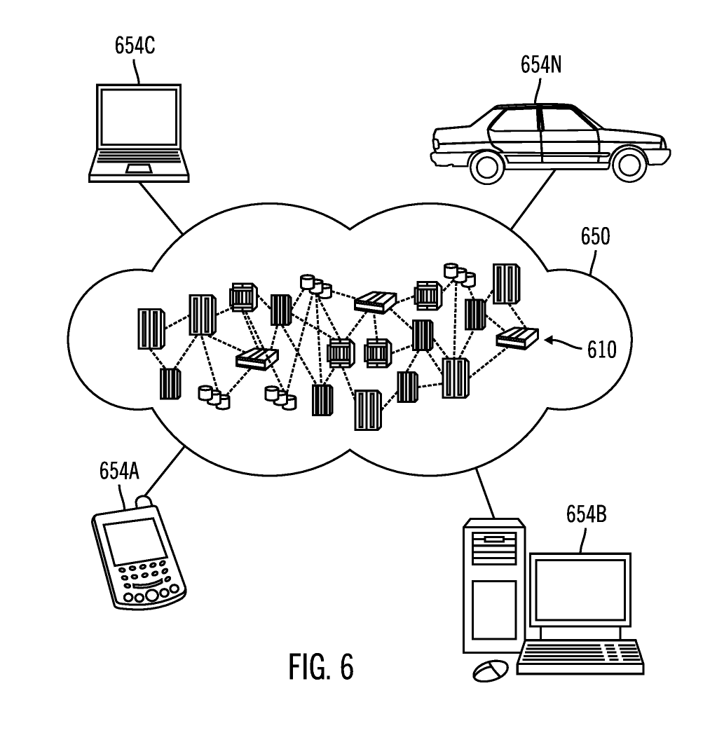

Referring now to FIG. 6, illustrative cloud computing environment 650 is depicted. As shown, cloud computing environment 650 includes one or more cloud computing nodes 610 with which local computing devices used by cloud consumers, such as, for example, personal digital assistant (PDA) or cellular telephone 654A, desktop computer 654B, laptop computer 654C, and/or automobile computer system 654N may communicate. Nodes 610 may communicate with one another. They may be grouped (not shown) physically or virtually, in one or more networks, such as Private, Community, Public, or Hybrid clouds as described hereinabove, or a combination thereof. This allows cloud computing environment 650 to offer infrastructure, platforms and/or software as services for which a cloud consumer does not need to maintain resources on a local computing device. It is understood that the types of computing devices 654A-N shown in FIG. 6 are intended to be illustrative only and that computing nodes 610 and cloud computing environment 650 can communicate with any type of computerized device over any type of network and/or network addressable connection (e.g., using a web browser).

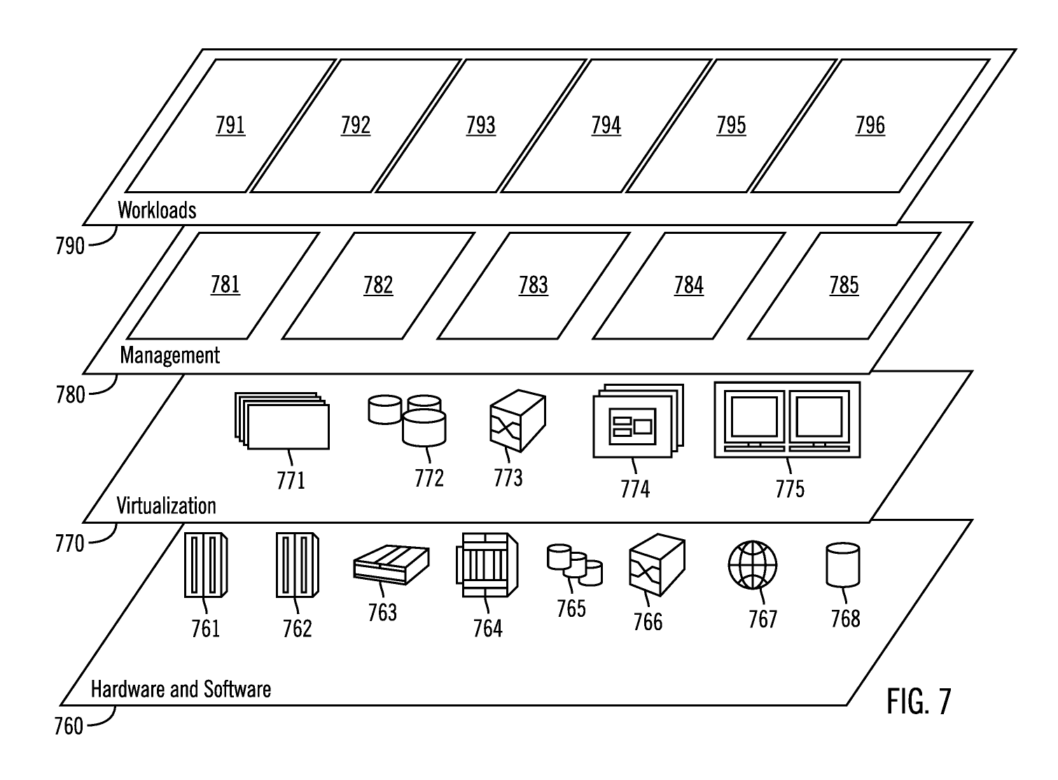

Referring now to FIG. 7, a set of functional abstraction layers provided by cloud computing environment 650 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 760 includes hardware and software components. Examples of hardware components include: mainframes 761; RISC (Reduced Instruction Set Computer) architecture based servers 762; servers 763; blade servers 764; storage devices 765; and networks and networking components 766. In some embodiments, software components include network application server software 767 and database software 768.

Virtualization layer 770 provides an abstraction layer from which the following examples of virtual entities may be provided: virtual servers 771; virtual storage 772; virtual networks 773, including virtual private networks; virtual applications and operating systems 774; and virtual clients 775.

In one example, management layer 780 may provide the functions described below. Resource provisioning 781 provides dynamic procurement of computing resources and other resources that are utilized to perform tasks within the cloud computing environment. Metering and Pricing 782 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 783 provides access to the cloud computing environment for consumers and system administrators. Service level management 784 provides cloud computing resource allocation and management such that required service levels are met. Service Level Agreement (SLA) planning and fulfillment 785 provide pre-arrangement for, and procurement of, cloud computing resources for which a future requirement is anticipated in accordance with an SLA.

Workloads layer 790 provides examples of functionality for which the cloud computing environment may be utilized. Examples of workloads and functions which may be provided from this layer include: mapping and navigation 791; software development and lifecycle management 792; virtual classroom education delivery 793; data analytics processing 794; transaction processing 795; and heuristic and non-semantic means to predict cost of document review 796

Thus, in certain embodiments, software or a program, implementing heuristic and non-semantic means to predict cost of document review in accordance with embodiments described herein, is provided as a service in a cloud environment.

### ADDITIONAL EMBODIMENT DETAILS

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, to machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer system implemented method, comprising:
accessing, by the computer system, a corpus of documents for a domain;
accessing, by the computer system, terms associated with the domain, wherein the terms have an order on a list, with terms having more relative importance to the domain being higher on the list;
for each of the documents,
determining, by the computer system, term positional dispersion for each of the terms in the ordered list associated with the domain using a number of term occurrences in the document for a given term, a positional mean of relative position of the given term in the document, and a positional value of the given term at a particular position; and
determining, by the computer system, a document review quanta for the document based on a summation of the term positional dispersion for each term in that document adjusted by a weight; and
selecting, by the computer system, a subset of documents in the corpus of documents that are to be reviewed based on the document review quanta for each of the selected documents exceeding a threshold.

2. The method of claim 1, further comprising:
ranking each of the documents in the corpus based on the document review quanta for each of the documents.

3. The method of claim 1, further comprising:
determining a total review quanta for each of the documents that takes into account weighted factors of term sensitivity, size, language, term positional dispersion, and history.

4. The method of claim 3, further comprising:
determining a predicted total review cost for the corpus of documents based on a summation of the total review quanta for each of the documents in the corpus of documents and based on an average review cost per unit.

5. The method of claim 4, further comprising:
comparing the predicted total review cost for the corpus of documents to an actual review cost based on historical data; and
updating weights of the weighted factors based on the comparison.

6. The method of claim 1, wherein a Software as a Service (SaaS) is configured to perform method operations.

7. A computer program product, the computer program product comprising a computer readable storage medium having program code embodied therewith, the program code executable by at least one processor to perform:
accessing a corpus of documents for a domain;
accessing terms associated with the domain, wherein the terms have an order on a list, with terms having more relative importance to the domain being higher on the list;
for each of the documents,
determining term positional dispersion for each of the terms in the ordered list associated with the domain using a number of term occurrences in the document for a given term, a positional mean of relative position of the given term in the document, and a positional value of the given term at a particular position; and
determining a document review quanta for the document based on a summation of the term positional dispersion for each term in that document adjusted by a weight; and
selecting a subset of documents in the corpus of documents that are to be reviewed based on the document review quanta for each of the selected documents exceeding a threshold.

8. The computer program product of claim 7, wherein the program code is executable by the at least one processor to perform:
ranking each of the documents in the corpus based on the document review quanta for each of the documents.

9. The computer program product of claim 7, wherein the program code is executable by the at least one processor to perform:
determining a total review quanta for each of the documents that takes into account weighted factors of term sensitivity, size, language, term positional dispersion, and history.

10. The computer program product of claim 9, wherein the program code is executable by the at least one processor to perform:
determining a predicted total review cost for the corpus of documents based on a summation of the total review quanta for each of the documents in the corpus of documents and based on an average review cost per unit.

11. The computer program product of claim 10, wherein the program code is executable by the at least one processor to perform:
comparing the predicted total review cost for the corpus of documents to an actual review cost based on historical data; and
updating weights of the weighted factors based on the comparison.

12. The computer program product of claim 7, wherein a Software as a Service (SaaS) is configured to perform computer program product operations.

13. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more memories, to perform operations comprising:
accessing a corpus of documents for a domain;
accessing terms associated with the domain, wherein the terms have an order on a list, with terms having more relative importance to the domain being higher on the list;
for each of the documents,
determining term positional dispersion for each of the terms in the ordered list associated with the domain using a number of term occurrences in the document for a given term, a positional mean of relative position of the given term in the document, and a positional value of the given term at a particular position; and
determining a document review quanta for the document based on a summation of the term positional dispersion for each term in that document adjusted by a weight; and
selecting a subset of documents in the corpus of documents that are to be reviewed based on the document review quanta for each of the selected documents exceeding a threshold.

14. The computer system of claim 13, wherein the operations further comprise:
ranking each of the documents in the corpus based on the document review quanta for each of the documents.

15. The computer system of claim 13, wherein the operations further comprise:
determining a total review quanta for each of the documents that takes into account weighted factors of term sensitivity, size, language, term positional dispersion, and history.

16. The computer system of claim 15, wherein the operations further comprise:
determining a predicted total review cost for the corpus of documents based on a summation of the total review quanta for each of the documents in the corpus of documents and based on an average review cost per unit.

17. The computer system of claim 16, wherein the operations further comprise:
comparing the predicted total review cost for the corpus of documents to an actual review cost based on historical data; and
updating weights of the weighted factors based on the comparison.

18. The computer system of claim 13, wherein a Software as a Service (SaaS) is configured to perform computer system operations.
